(19) United States
(12) Patent Application Publication
(10) Pub. No.: US 2010/0018939 A1
(43) Pub. Date: Jan. 28, 2010

(54) Infant Feeding Container

(75) Inventors: Robert W. Strickler, San Jose, CA (US); Daniel K. Harden, Palo Alto, CA (US)

Correspondence Address: PATENT LAW GROUP LLP, 2635 NORTH FIRST STREET, SUITE 223, SAN JOSE, CA, 95134, US

(73) Assignee: ADIRI, INC., Palo Alto, CA (US)

(21) Appl. No.: 12/572,470

(22) Filed: Oct. 2, 2009

Related U.S. Application Data
(63) Continuation of application No. 11/539,572, filed on Oct. 6, 2006, now Pat. No. 7,600,647.

(51) Int. Cl. A61J 9/08

(52) U.S. Cl. 215/11.6

(57) ABSTRACT

An infant feeding container is disclosed to provide a feeding experience closely resembling natural breast feeding. The container includes a first part having a rigid substrate and a pliant over-mold having a first portion unsupported by the substrate and a second portion molded over and supported by the substrate. The first portion has a breast-like shape and a ducted nipple. The container further includes a second part for engaging the first part to seal the container.

### CROSS REFERENCE TO RELATED APPLICATIONS

This is a Continuation of U.S. patent application Ser. No. 11/539,572, entitled “Infant Feeding Container,” filed on Oct. 6, 2006, which is incorporated by reference.

### FIELD OF INVENTION

The present invention relates to infant feeding containers, more specifically to one which has the approximate form, feel, and function of a natural breast.

### DESCRIPTION OF RELATED ART

It is widely known that natural breast feeding is the best way to nurture an infant. The quality of mother's milk is superior to prepared formulas and the act of providing an infant with the mother's warm breast and comfort is an important aspect of proper child development and bonding between mother and infant. However, artificial feeding systems may be desirable or necessary in some circumstances. These include medical situations such as premature births, mothers who have had mastectomies or who are unable to lactate sufficiently, infants who require dietary supplements, and health problems such as cleft pallet or breast abscesses. Social situations requiring artificial feeding include employed women who are unable to feed their infants at work, women who use breast pumps and require containers for feeding, the need to feed adopted infants, and other medical or social situations that may recommend the use of an artificial container.

Healthcare professionals agree that an infant's sensory experience is particularly important in the formative stages of development, and especially in the feeding process. While artificial feeding containers can never fully imitate a mother, the breast-like infant feeding containers disclosed in commonly assigned U.S. Pat. Nos. 5,690,679 and 5,993,479 provide a far more natural sensory experience for infants when artificial feeding means are needed.

Many of the baby bottles now in use may be cited for various shortcomings, the greatest being the unnaturalness of nursing from a rigid, angular, elongate container, often in contact with an infant's cheeks, chin, nose and hands. This results in a predominance of unnatural sensory experience that is inappropriate, particularly for newborn infants. Although artificial nipples are typically soft, they do not provide a sensory experience similar to the comforting feeling of breast feeding wherein an infant is often in full contact with the mother's soft, warm breast. Furthermore, rigid bottles can cause infants to ingest unnecessary amounts of air. While the latter issues are addressed by recent innovations in infant feeding systems, no existing container, other than the ones referenced in commonly assigned U.S. Pat. Nos. 5,690,679 and 5,993,479, offers the combination of form, feel and function comparable to natural breast feeding.

### SUMMARY

In one or more embodiments of the invention, an infant feeding container comprises a first part and a second part. The first part includes a rigid substrate and a pliant over-mold having a first portion unsupported by the substrate and a second portion molded over and supported by the substrate. The first portion has a breast-like shape and a ducted nipple. The second part engages the first part to seal the container.

### BRIEF DESCRIPTION OF THE DRAWINGS

FIGS. 1 and 2 illustrate exploded views of an infant feeding container in one embodiment of the invention.

FIG. 3 illustrates an exploded view of the infant feeding container of FIGS. 1 and 2 where a bottle body and a lid are further broken down into their components in one embodiment of the invention.

FIG. 4 illustrates a cross-section of the infant feeding container of FIGS. 1 and 2 in one embodiment of the invention.

FIG. 5 illustrates a perspective view of the infant feeding container of FIGS. 1 and 2 in one embodiment of the invention.

Use of the same reference numbers in different figures indicates similar or identical elements.

### DETAILED DESCRIPTION

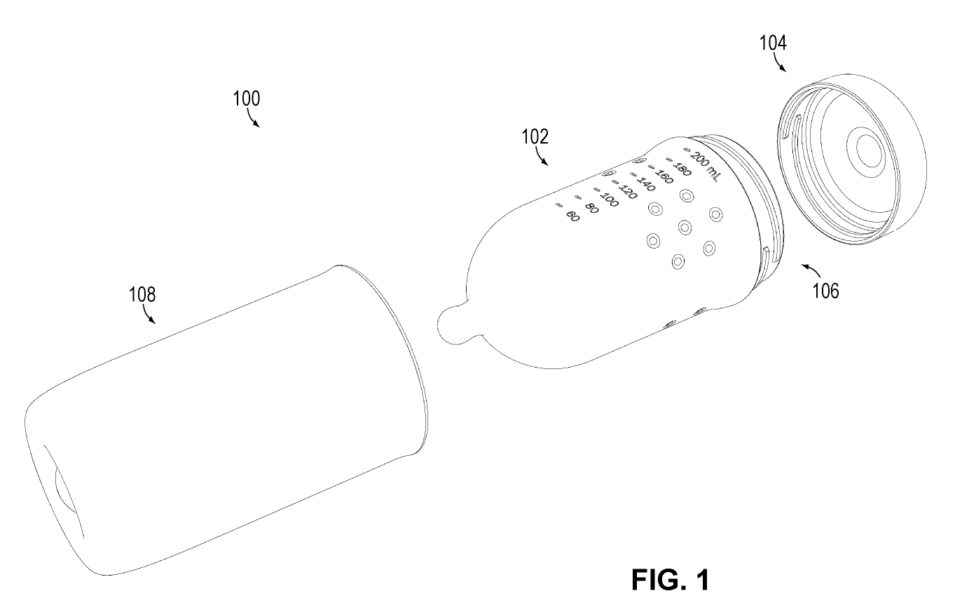

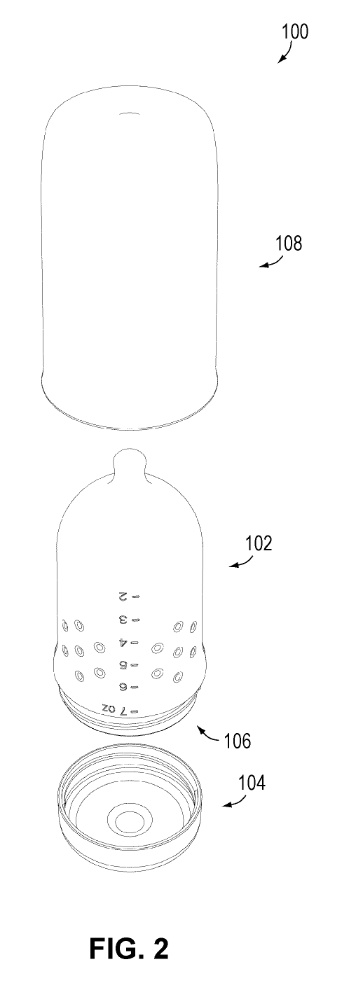

FIGS. 1 and 2 illustrate a baby feeding container 100 in one embodiment of the invention. Container 100 includes a bottle body 102, a lid 104 for securing an open end 106 of body 102, and a cover 108 for enclosing at least part of body 102. In one embodiment, body 102 and lid 104 are each an integral piece made in an over-mold process. In one embodiment, body 102 has a diameter of approximately 60 to 68 mm and a length of approximately 140 mm.

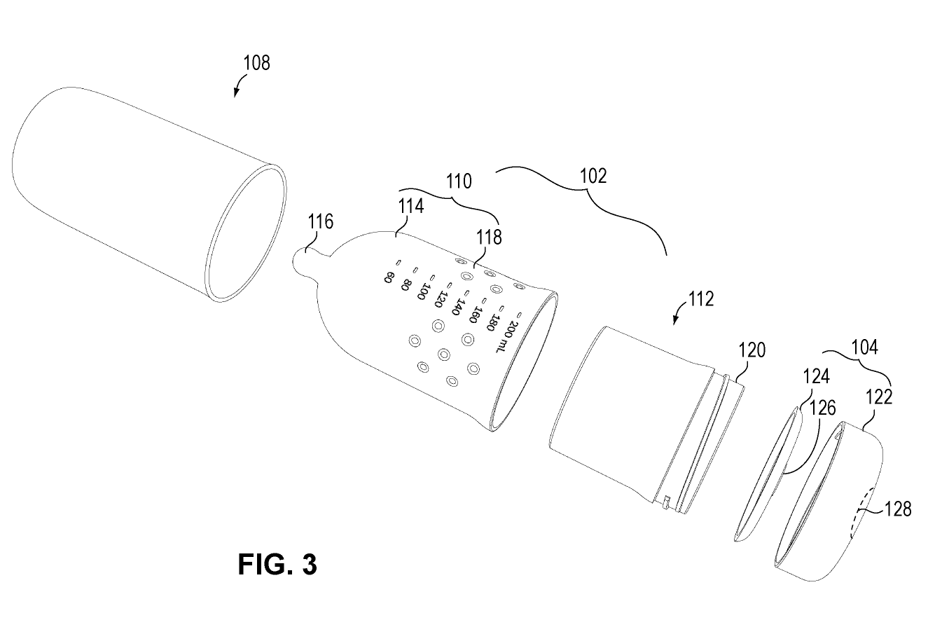

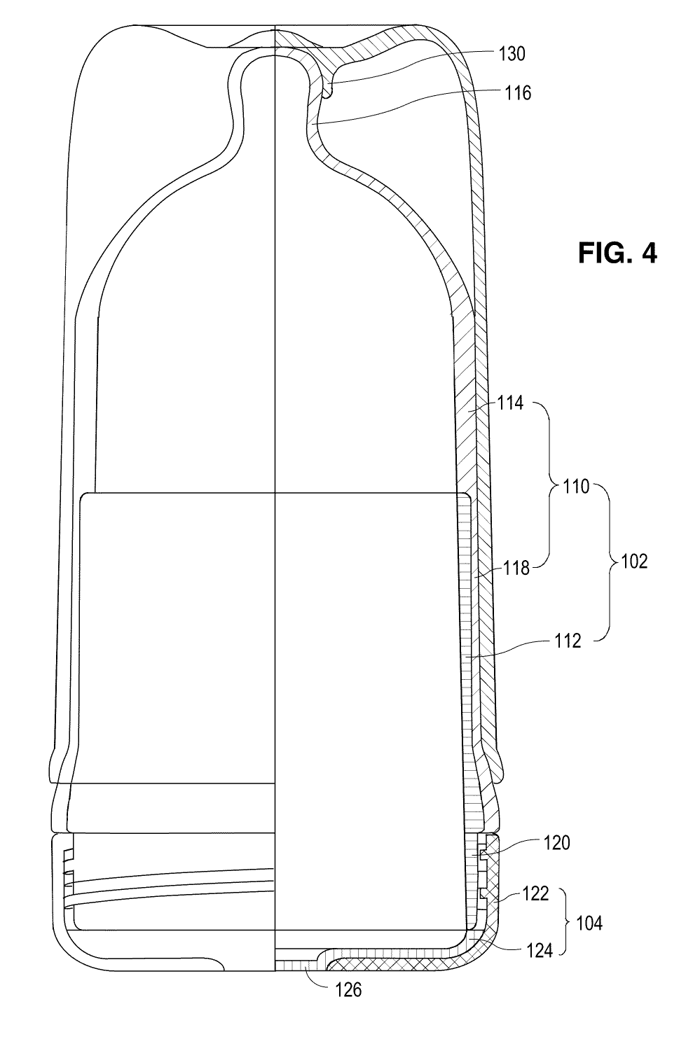

FIGS. 3 and 4 illustrate container 100 where the components of body 102 and lid 104 are further labeled in one embodiment of the invention. Body 102 has a pliant over-mold 110 molded over a rigid substrate 112. Substrate 112 is first molded and then over-mold 110 is molded over substrate 112. Over-mold 110 has a dome shaped portion 114 with a ducted nipple 116 at the crest. Dome shaped portion 114 is not supported by substrate 112 so it remains pliant. Over-mold 110 further has a cylindrical portion 118 supported by substrate 112. Thus, cylindrical portion 118 has the shape of substrate 112. Over-mold 110 may be made from silicone, rubber, latex, thermoplastic elastomer, or another suitable pliant material. Substrate 112 is a cylinder with a threaded neck 120. Substrate 112 may be made from nylon, polycarbonate, polysulfone, or another suitable rigid material.

Dome shaped portion 114 is formed in the approximate shape of a breast. Dome shaped portion 114 is greater in size than a nipple on a conventional baby bottle. When filled with a warm liquid, dome shaped portion 114 provides soft and warm facial contact to an infant during feeding. This provides a feeding experience closely resembling natural breast feeding. In contrast, an infant feeding from a conventional baby bottle does not have warm and soft facial contact with the nipple or the bottle.

Cylindrical portion 118 over substrate 112 provides a rigid shape with a pliant surface that a caretaker can easily grip. The pliant nature of cylindrical portion 118 improves the overall grip on container 100. The surface of cylindrical portion 118 may be dimpled or otherwise patterned to further improve the grip on container 100. The surface of over-mold 110 may be marked to indicate the volume of the liquid content in container 100.

Lid 104 has a threaded screw cap 122 and a cap seal 124 located on the bottom surface of screw cap 122. Screw cap 122 is first molded and then cap seal 124 is molded into screw cap 122. Screw cap 122 may be made from nylon, polycarbonate, acrylic, or other suitable rigid material. Cap seal 124 may be made from thermoplastic elastomer or other suitable pliant material.

When screw cap 122 is screwed onto threaded neck 120 of substrate 112, the bottom of substrate 112 contacts cap seal 124 to securely seal the liquid contents of container 100. Cap seal 124 includes a vent 126 that allows air to enter container 100 as the liquid content exits container 100 through ducted nipple 116. Vent 126 protrudes outward from an opening 128 (shown in phantom in FIG. 3) in screw cap 122.

Cover 108 fits over the outer surface of body 102 to at least enclose dome shaped portion 114. Cover 108 has an inner surface that forms a cap 130 (FIG. 4) for engaging ducted nipple 116 to prevent the liquid content from leaking.

To fill container 100, the caretaker fits cover 108 over body 102 so that ducted nipple 116 is capped. The caretaker then turns body 102 upside down and fills it with the liquid content. Once filled, the caretaker screws lid 104 onto body 102.

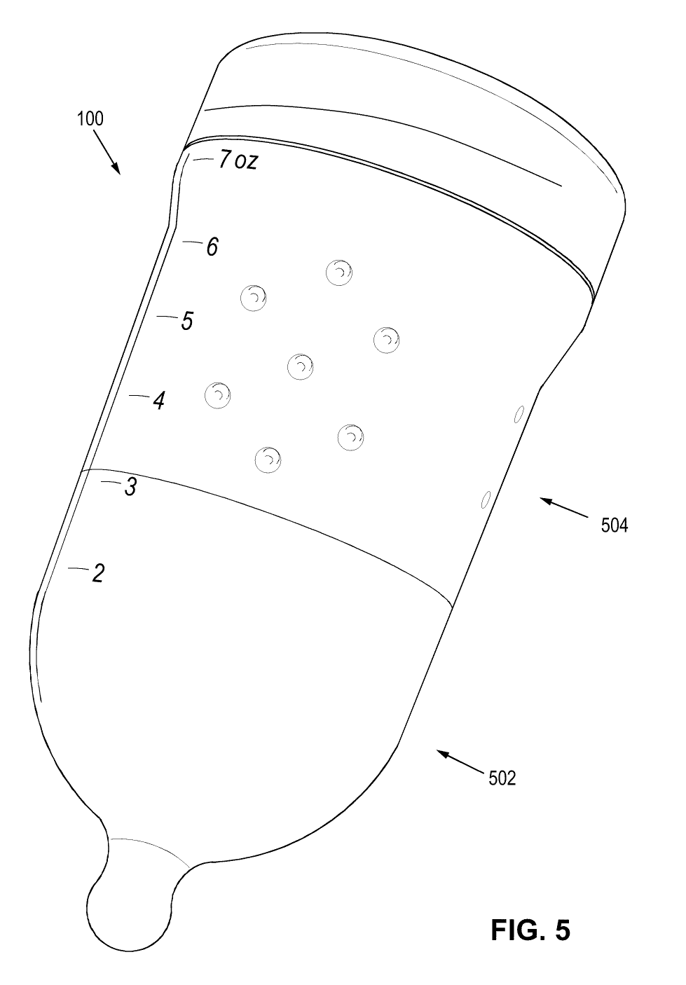

FIG. 5 illustrates a view of the assembled container 100 in one embodiment. Container 100 essentially has a body with a pliant dome shaped portion 502 and a rigid cylindrical portion 504. As described above, pliant dome shaped portion 502 is formed from portion 114 of over-mold 110 unsupported by substrate 112 and rigid cylindrical portion 504 is formed from portion 118 of over-mold 110 supported by substrate 112.

Container 100 offers advantages over a conventional baby bottle. First, container 100 provides a more natural feeding experience. As described above, container 100 offers soft and warm facial contact during feeding that closely resembles natural breast feeding. Second, container 100 has fewer parts than a conventional baby bottle. As described above, container 100 consists of a bottle body with a nipple, a lid for securing an opening of the body, and a cover for the nipple. A conventional baby bottle often consists of a bottle, a nipple, a collar for securing the nipple to the bottle, a nipple plug that fits between the collar and the bottle, and a cover for the nipple.

Various other adaptations and combinations of features of the embodiments disclosed are within the scope of the invention. Numerous embodiments are encompassed by the following claims.

What is claimed is:

1. An infant feeding container, comprising:
a first part, comprising:
a rigid substrate;
a pliant over-mold having a first portion unsupported by the substrate and a second portion molded over and supported by the substrate, the first portion having a breast-like shape and a ducted nipple; and
a second part for engaging the first part to seal the container.

2. The container of claim 1, wherein the first portion comprises a dome-like portion with the ducted nipple located on a crest of the dome-like portion.

3. The container of claim 1, further comprising a cover shielding at least part of an outer surface of the first part.

4. The container of claim 1, wherein the substrate comprises a first cylindrical portion and the second part comprises a second cylindrical portion for engaging the first cylindrical portion of the substrate to seal the container.

5. The container of claim 4, wherein the first cylindrical part comprises a thread and the second cylindrical part comprises a complementary thread for engaging the thread on the first cylindrical part to seal the container.

6. An infant feeding container comprising:
a first component comprising a pliant material comprising a first end having a breast-like shape and a ducted nipple and a second end having a first circular opening;
a second component comprising a rigid material having a second circular opening at a first end of the second component,
wherein the second circular opening is smaller than the first circular opening, the first component fits over the second component through the first circular opening, and the first component has a length to extend past at least the second circular opening of the second component and overlap at least a portion of the second component; and
a third component comprising a cover to enclose the first component, wherein the third component fits over the first component, the third component has a length to extend past at least the second circular opening of the second component and overlap at least a portion of the first and second components.

7. The infant feeding container of claim 6, further comprising male threads formed around an outside of the second component.

8. The infant feeding container of claim 6, wherein a volume of the liquid in the infant feeding container is viewable through the second component.

9. The infant feeding container of claim 6, wherein when a warm liquid is in the infant feeding container, warmth of the warm liquid is transmitted through the first component.

10. The infant feeding container of claim 6, wherein the portion of the second component overlapped by the first component comprises a cylindrical shape.

11. The infant feeding container of claim 6, further comprising graduated markings in milliliters on a side of infant feeding container.

12. The infant feeding container of claim 6, wherein the infant feeding container holds at least 200 milliliters of liquid.

13. The infant feeding container of claim 6, wherein the first component is overmolded to the second component.

14. The infant feeding container of claim 6, wherein the first component comprises silicone and the second component comprises a nylon.

15. The infant feeding container of claim 6, wherein a diameter of the second component is at least 60 millimeters.

16. An infant feeding container comprising:
a first component comprising a pliant material comprising silicone and a first end having a breast-like shape and a ducted nipple and a second end having a first circular opening,
wherein the first component transmits a warmth of the warm liquid being held in the infant feeding container;
a second component comprising a rigid material having a second circular opening at a first end of the second component,
wherein the second circular opening is smaller than the first circular opening, the first component fits over the second component through the first circular opening, and the first component has a length to extend past at least the second circular opening of the second component and overlap at least a portion of the second component, and
the portion of the second component overlapped by the first component comprises a cylindrical shape, the second component has a diameter of at least 60 millimeters, and male threads are formed around the second component; and
a third component comprising a cover to enclose the first component, wherein the third component fits over the first component, the third component has a length to extend past at least the second circular opening of the second component and overlap at least a portion of the first and second components, and
wherein graduated markings in milliliters are on a side of infant feeding container.

17. The infant feeding container of claim 16, wherein the first component is overmolded to the second component.

18. The infant feeding container of claim 16, wherein the markings are graduated in 20 milliliter increments.

19. The infant feeding container of claim 16, wherein the infant feeding container holds at least 200 milliliters of liquid.

20. The infant feeding container of claim 16, wherein a volume of the liquid in the infant feeding container is viewable through the second component.
